(19) United States
(12) Patent Application Publication
(10) Pub. No.: US 2015/0047577 A1
(43) Pub. Date: Feb. 19, 2015

(54) PET GARMENT

(71) Applicant: Lisa Schnieder, Bonnyville (CA)

(72) Inventor: Lisa Schnieder, Bonnyville (CA)

(21) Appl. No.: 13/967,032

(22) Filed: Aug. 14, 2013

(51) Int. Cl. A01K 13/00

(52) U.S. Cl. CPC A01K 13/007
USPC 119/850

(57) ABSTRACT

The present invention is directed to a dog garment comprising a torso portion, a neck portion, a front leg portion, a hind leg portion and a foot portion at each of the terminal ends of the front leg and hind leg portions, wherein said dog garment is made of a waterproof, thermally insulating material.

### BACKGROUND OF THE INVENTION

1. Technical Field

The present invention relates to dog clothing that pertains to protecting a dog from inclement weather while allowing unrestricted movement.

2. Description of Related Art

Many people who own dogs live in geographical regions that experience long, cold winters where daytime high temperatures often stay below well below freezing (i.e., 0° C.) for weeks or months at a time. Despite such freezing temperatures the dogs must be allowed outdoors several times a day to relieve themselves. This presents significant problems, particularly when the ground is covered in ice, snow or slush, because the dog's pads get very cold and can become embedded with marble-sized pieces of ice. Consequently, the dog may be reluctant to go outside, and when outside, may seek to re-enter the home before relieving itself. Further, once the dog re-enters the home, its paws must be dried and any pieces of ice embedded in its pads must be removed. This is a laborious process for the dog-owner, and causes the dog significant discomfort.

Dog-owners who live in geographical regions that experience extremely hot temperatures encounter a similar, if less serious, problem. On days with particularly high temperatures, for example, above about 30° C., walking surfaces may become too hot for the dog's pads, thereby preventing the dog-owner from taking the dog for a walk.

U.S. patent publication 20070193532 describes a dog apparel that is intended for indoor use. The apparel encloses the body of a dog to protect homes and vehicles against undesirable debris located on or about the body of the animal. The apparel is not intended to protect the dog, or its pads, from inclement weather. Instead, it is used so as to prevent dander, mud, dirt, water and other materials commonly found on a dog's body from being transferred to an individual's home, auto or area that is to be kept clean.

U.S. patent publication 2008115738 (the '738 publication) describes an animal coat for protecting the animal from inclement weather, particularly cold weather. The coat is said to include an improved means fro securing the coat to the animal. However, because the coat is not intended to protect a dog's pads from cold or hot surfaces, the coat described in the '738 publication does not enclose the animal's feet.

U.S. Pat. No. 6,024,055 (the '055 patent) describes a pullover dog sweater that fully encloses the torso portion of the dog's body and the dog's legs and feet. The sweater is made of a knit material and, because it is a pullover sweater, lacks a closure means in the neck portion. It therefore is placed on the dog by slipping the neck portion over the dog's head. In addition to lacking a closure means in the neck portion, the pullover sweater described in the '055 patent lacks a leash attachment opening.

U.S. Pat. No. 3,742,679 (the '679 patent) describes a stretchable pet suit with boots. The pet suit has elasticized strips along the legs, which are detachably connected to the boots with elastic straps and fasteners. Because the boots are detachably couple to the legs, the pet suit of the '679 patent has the advantage of allowing the owner to utilize only the torso portion when providing the animal when protection for its feet is unnecessary. On the other hand, for the same reason, when protecting the animal's feet is desired the suit is less convenient because placing the suit on the animal becomes a multi-step process. That is, after placing the main portion of the suit on the animal each of the boots must be affixed to a leg of the suit. This pet suit lacks a closure means in the neck portion, and is instead secured to the animal via a zipper running along the back portion. The neck portion also does not have a leash attachment opening.

Thus, there exists a continuing need for a convenient dog garment that is well suited for protecting a dog from inclement weather while simultaneously protecting the dog's pads from cold surfaces, such as snow and ice, as well as for protecting the dog's pads from hot surfaces, such as hot asphalt. The present invention substantially fulfills this need.

### SUMMARY OF THE INVENTION

The present invention is directed to a dog garment comprising: (a) a torso portion that substantially covers the back and lateral sides of the torso of a dog, the torso portion having a neck opening and a rear opening; (b) a neck portion extending from the torso portion and arranged to encase the neck of the dog, the neck portion comprising a closure means for securing the garment to the dog; (c) a front leg portion extending from the torso portion, the front leg portion arranged to encase the front legs of the dog; (d) a hind leg portion extending from the torso portion, the hind leg portion arranged to encase the hind legs of the dog; and (e) a foot portion at each of the terminal ends of the front and hind leg portions; wherein said dog garment is made of a waterproof, thermally insulating material.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a side illustration of an embodiment of the dog garment.

FIG. 2 is a bottom view of the present invention.

FIG. 3 is a front view of the present invention.

FIG. 4 is a rear view of the present invention.

In the following description of the invention similar reference characters refer to similar parts throughout the several views of the drawings.

### DETAILED DESCRIPTIONS

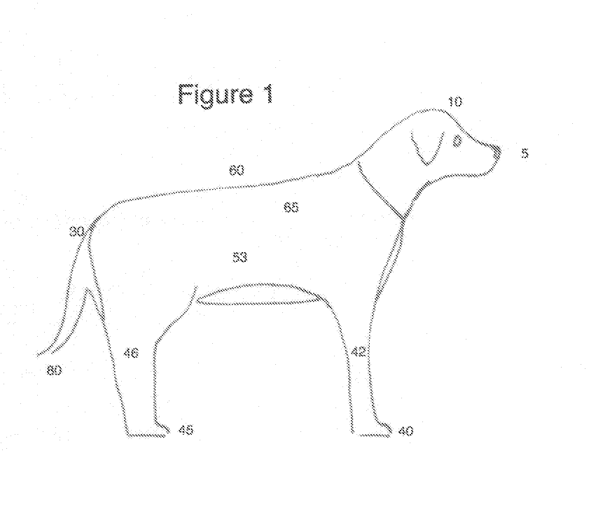

FIG. 1 shows dog 5 wearing dog garment 55. Dog 5 has a head 10, a body 60, front feet 40, hind feet 45 and a tail 80. Dog garment 55 covers every part of dog 5 except the head 10, chest area 35, neck 25, underbelly 50, hind end 30 and tail 80. Dog garment 55 contains torso portion 60, which is contiguous with front leg portion 42 and hind leg portion 46. Torso portion 60 covers lateral sides 53 and back 15. Neck portion 27 of garment 55 covers part of dog neck 25. Tail 80 is not covered by dog garment 55, and is exposed along with hind end 30. Dog garment 55 also contains a leash attachment opening 65 and closure means 23.

Dog garment 55 is comprised of a fabric, such as, for example, fleece, that is waterproof and thermally insulating, thereby providing the dog with protection from inclement weather. Dog garment 55 also may contain elastic material to allow for stretching in front leg portion 42 and hind leg portion 46 to accommodate different sized dogs. In addition, dog garment 55 also may contain elastic material in torso 60 to allow for stretching in that area as well.

Of course, certain fabrics may be better suited for protecting the dog, particularly the dog's pads, from cold surfaces, such as snow and ice, whereas other fabrics may be better suited for protecting the dog's pads from hot surfaces, such as hot asphalt. Still other fabrics may be better suited for protecting the dog from wet surfaces, such as wet concrete or asphalt, wet grass, puddles and marshy areas, or from rain, sleet or snow. Fleece has been found to be an especially suitable fabric for protecting the dog's pads from snow and ice, and in preventing pieces of ice from becoming lodged within the dog's pads. Fleece also has the advantage of being machine washable and machine dryable, thereby greatly facilitating the process of cleaning the garment following its use.

In certain instances it may be preferable that the garment be made from more than one type of fabric. For example, in hot environments the leg portions of the garment, or even simply the feet portions of the garment, may be made of fleece so as to provide the dog with protect against hot surfaces, such as hot asphalt, while the remainder of the garment may be made of a lighter mesh material that is less thermally insulating than fleece.

Likewise, in certain instances it may be preferable that the garment be made of a fabric that is more waterproof than fleece, such as, for example, Goretex®. Such fabrics may be particularly suitable in environments where the main objective is to protect the dog from wet surfaces, such as wet concrete or asphalt, wet grass, puddles and marshy areas.

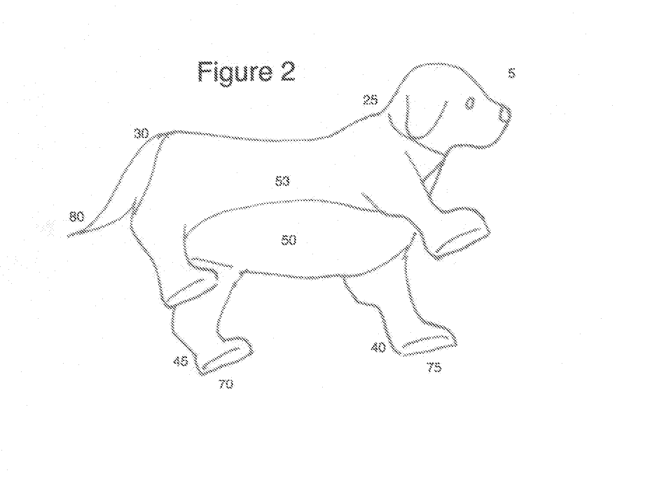

FIG. 2 shows dog 5 having neck 25, front feet 40, front feet pads 75, underbelly 50, hind feet 45, hind feet pads 70, hind end 30 and tail 80. FIG. 2 shows that dog garment 55 does not cover underbelly 50. Underbelly 50 is exposed to allow dog 5 optimal movement. FIG. 2 also demonstrates that lateral sides 53 are covered by garment 55. Dog garment 55 also covers hind feet pads 70 and front feet pads 75. Garment 55 provides thermal insulation and a waterproof barrier for hind feet pads 70, front feet pads 75, lateral sides 53 and part of neck 25.

In certain embodiments dog garment 55 may be made of more than one material, such as when the portion of the garment covering the pads of the dog's feet are made of a material that provides greater waterproof protection than other areas of the garment. Alternatively, when it is desirable to provide greater waterproof protection for the dog's feet and/or feet pads, a second layer of material smay be added to those portion of the dog garment.

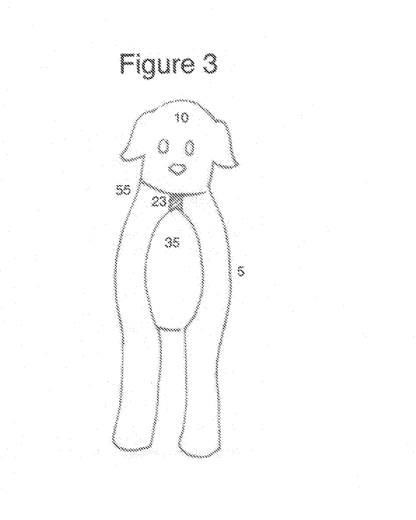

FIG. 3 shows a frontal view of dog garment 55 on dog 5. The head 10 is exposed and not protected by dog garment 55. As demonstrated in this figure, chest area 35 also is not covered by dog garment 55. Closure means 23 connects one side of neck portion 27 to the other side of neck portion 27, thereby securing dog garment 55 to dog 5.

Closure means 27 may be any mechanical fastener which facilitates connecting one side of neck portion 27 to the other side of neck portion 27. Such mechanical fasteners include, for example, a hook-and-loop fastener, a snap, a clip, a button or any combination thereof. In one embodiment, the closure means is a hook-and-loop fastener.

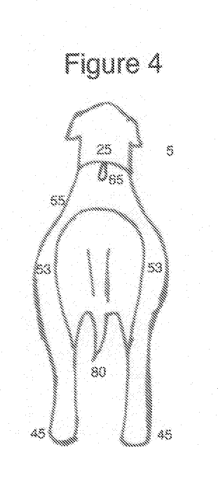

FIG. 4 shows a posterior view of dog 5 wearing dog garment 55. This view shows that dog garment 55 does not cover either hind end 30 or tail 80, thereby leaving them. This view further shows that dog garment 55 covers lateral sides 53 and hind feet 45. This view also shows leash attachment opening 65 and neck 25.

While particular embodiments of the present invention have been shown and described herein for purposes of illustration, it will be understood that the invention is not limited thereto. Modifications may be made by persons skilled in the art, particularly in light of the foregoing teachings, without deviating from the spirit and scope of the invention. Accordingly, the invention is not limited except as by the appended claims.

All of the U.S. patents and published U.S. patent applications referred to in this specification are incorporated herein by reference in their entirety to the extent not inconsistent with the present description.

What is claimed is:

1. A dog garment comprising:
(a) a torso portion that substantially covers the back and lateral sides of the torso of a dog, said torso portion having a neck opening and a rear opening;
(b) a neck portion extending from said torso portion and arranged to encase the neck of the dog, said neck portion comprising a closure means for securing the garment to the dog;
(c) a front leg portion extending from said torso portion, said front leg portion arranged to encase the front legs of the dog;
(d) a hind leg portion extending from said torso portion, said hind leg portion arranged to encase the hind legs of the dog; and
(e) a foot portion at each of the terminal ends of said front leg portion and said hind leg portion;
wherein said dog garment is made of a waterproof, thermally insulating material.

2. A dog garment according to claim 1, further comprising a leash attachment opening.

3. A dog garment according to claim 2, wherein said leash attachment opening is located on the neck portion of said dog garment.

4. A dog garment according to claim 1, wherein said closure means is a mechanical fastener.

5. A dog garment according to claim 4, wherein said mechanical fastener comprises a hook-and-loop fastener, a snap, a clip or a button.

6. A dog garment according to claim 4, wherein said closure means is located on the neck portion of said dog garment.

7. A dog garment according to claim 1, wherein said dog garment is one continuous piece.

8. A dog garment according to claim 1, said torso portion being substantially open at the underbelly.

9. A dog garment according to claim 1, wherein each of said leg portions comprises an elastic material.

10. A dog garment according to claim 1, wherein said thermally insulating material is machine washable and dryable.

11. A dog garment according to claim 10, wherein said thermally insulating, machine washable and dryable material is fleece.

12. A dog garment comprising:
(a) a torso portion that substantially covers the back and lateral sides of the torso of a dog, said torso portion having a neck opening and a rear opening;
(b) a neck portion extending from said torso portion and arranged to encase the neck of the dog;
(c) a front leg portion extending from said torso portion, said front leg portion arranged to encase the front legs of the dog;
(d) a hind leg portion extending from said torso portion, said hind leg portion arranged to encase the hind legs of the dog; and
(e) a foot portion at each of the terminal ends of said front leg portion and said hind leg portion;
wherein said dog garment is made of a waterproof, thermally insulating material.

13. A dog garment according to claim 12, further comprising a leash attachment opening.

14. A dog garment according to claim 13, wherein said leash attachment opening is located on the neck portion of said dog garment.

15. A dog garment according to claim 12, wherein said dog garment is one continuous piece.

16. A dog garment according to claim 12, said torso portion being substantially open at the underbelly.

17. A dog garment according to claim 12, wherein each of said leg portions comprises an elastic material.

18. A dog garment according to claim 12, wherein said neck portion comprises an elastic material.

19. A dog garment according to claim 12, wherein said thermally insulating material is machine washable and dryable.

20. A dog garment according to claim 19, wherein said thermally insulating, machine washable and dryable material is fleece.
